(19) United States
(12) Patent Application Publication
(10) Pub. No.: US 2018/0134002 A1
(43) Pub. Date: May 17, 2018

(54) WOVEN, NONWOVEN, AND EXPANDABLE GRAPHITE COMPOSITE MATERIAL

(71) Applicant: Tex Tech Industries, Inc., North Monmouth, ME (US)

(72) Inventors: David BRAHMS, South Portland, ME (US); Joshua WARD, Limington, ME (US)

(21) Appl. No.: 15/353,269

(22) Filed: Nov. 16, 2016

(51) Int. Cl. B32B 5/02; F16L 59/02; D04H 1/08; D04H 1/485

(52) U.S. Cl. CPC B32B 5/022; B32B 5/024; B32B 2307/3065; D04H 1/08; D04H 1/485; F16L 59/029

(57) ABSTRACT

A composite flame barrier includes at least one layer of nonwoven flame resistant fibers, and at least one layer of heat absorbing intumescing expandable graphite held together with polymeric binders and fire resistant fibers in a sheet structure. The composite material provides thermal protection that cannot be achieved using the expandable graphite is alone. By mechanically attaching a nonwoven felt or hydro-entangled nonwoven material to the layer containing expandable graphite, the graphite becomes stabilized and is more resistant to forces that may damage the material (wind, high velocity flames etc.) and decrease or eliminate the thermal performance of the expandable graphite. The composite flame barrier is useful in applications where prolonged fire and heat resistance is required, and has an advantage of being flexible and lightweight. The uses for the material include emergency portable fire shelters, structural protection of aircraft, structural steel fire proofing, fire-rated wall assemblies, and other fire-resistant applications.

### BACKGROUND OF THE INVENTION

The invention is in the field of passive fire protection and specifically relates to improvements in composite fire protection products incorporating intumescent materials, and methods of making the products.

U.S. Pat. No. 6,274,647 discloses a compressed composite material for passive fire protection comprising: inorganic fibers and organic fibers with an elastomeric binder forming a fibrous matrix, together with 10-85% of an exfoliating material, such as expandable graphite, vermiculite, or perlite. U.S. Pat. No. 6,274,647 is incorporated by reference herein for its teaching of flexible intumescent materials for fire protection.

U.S. Patent Application Publication No. 2015/0151510 discloses a composite heat and flame barrier material in which an active chemical layer, such as mineral hydrate, is mechanically contained, without a polymeric binder, between nonwoven layers of flame resistant fiber. U.S. Patent Application Publication No. 2015/0151510 is incorporated by reference for its teaching of an active chemical layer and nonwoven materials in fire protective materials.

### SUMMARY OF THE INVENTION

The inventors herein have developed materials and methods for fire protection which are flexible, lightweight, thin, and easily handled and installed, for construction projects and portable fire resistant applications such as small boxes, tents, or shelters. The composite flame or heat barrier materials according to the invention comprise a sheet of intumescent inorganic fire protection material integrated with at least one nonwoven layer. The fiber layers attached to the sheet of intumescent inorganic material provide additional insulation and protection to keep the composite material stabilized and resistant to wind and high velocity flames and the like.

In a first aspect of the invention there is provided a composite that includes at least one nonwoven fiber layer(s), including flame resistant fibers; and at least one sheet comprising expandable inorganic compound, glass or mineral fibers, and a polymeric binder; wherein the nonwoven fiber layer is mechanically attached to the sheet, so that fibers of the nonwoven layer are positioned in the z direction in the sheet of expandable inorganic material. For clarity, graphite is an inorganic compound, notwithstanding that it contains carbon.

In particular embodiments, the nonwoven fiber layer comprises up to 100% oxidized polyacrylonitrile (“OPAN”), and the sheet of expandable inorganic material comprises exfoliating graphite with glass or mineral fibers in a binder such as polyvinyl acetate (“PVA”). In particular embodiments, nonwoven fiber layer(s) are mechanically attached on opposite sides of the sheet of expandable inorganic material by needlepunching.

In another aspect, the invention is a composite comprising at least one nonwoven fiber layer(s) including flame resistant fibers, at least one sheet comprising expandable graphite, and further comprising a woven layer on a side of the expandable graphite sheet opposite the nonwoven layer. In embodiments, the woven and nonwoven fiber layers and the intumescing graphite sheet are integrated by needlepunching, so that fibers of the nonwoven layer are positioned in the z direction in the sheet of expandable inorganic material.

In another aspect, the invention is directed to a method of improving the hand-feel of a composite comprising intumescent graphite (or other expandable inorganic) and glass fibers, comprising positioning a layer of nonwoven oxidized polyacrylonitrile adjacent the composite and consolidating the layers by needlepunching.

In another aspect, the invention is directed to a pre-preg adapted for improved resin impregation. In this aspect, one or more nonwoven fire resistant fiber layers is attached by needlepunching to at least one sheet comprising expandable graphite in a matrix (which may include, for example, glass or mineral fibers and a polymeric binder). The needlepunching forms pores in the sheet of expandable inorganic which facilitates subsequent thermoplastic resin impregnation to make a composite for fire resistant applications.

### BRIEF DESCRIPTION OF THE DRAWINGS

FIG. 1 is a schematic depiction of composite material according to one embodiment of the invention.

FIG. 2 is a schematic depiction of a composite material according to another embodiment of the invention.

FIG. 3 is a comparative illustration of burn through performance of a composite material according to the invention and the prior art.

FIG. 4 is a schematic depiction of a composite material according to another embodiment of the invention, including an aluminum foil laminate outer layer on opposite sides of the composite.

FIG. 5 is a schematic depiction of another composite material having an aluminum foil outer layer on opposite sides of the composite.

### DETAILED DESCRIPTION OF THE PRESENT INVENTION

As used herein, the term “nonwoven” is intended to include sheet or web structures bonded together by entangling fibers mechanically, thermally, or chemically without weaving or knitting. Preferred nonwoven textiles include needlepunched, spunbond, or spunlace sheets or webs.

As used herein, “intumescing”, “intumescent”, etc. are used interchangeably with “expandable” to refer to exfoliating graphite, and certain other materials, as described in the aforesaid U.S. Pat. No. 6,274,647, which expand by a factor of at least 1.5, when heated, to form a heat or flame barrier.

As used herein, “composite” simply refers to any integral product made of different types of materials. Thus a combination of expandable inorganic material(s) in a matrix layer of glass fibers and/or mineral fibers may be referred to as a “composite”. Likewise, products of the invention may be further resin impregnated to make a different type of product as an end use, also referred to herein as a “composite”.

“About”, as used herein, means±15%. “Substantially”, when used herein to modify a characteristic, means that a real world deviation from the characteristic is negligible, and a person of skill may ignore the deviation for the purpose of making engineering calculations or decisions.

As used herein, a layer of textile is an x-y planar element, and the “z-direction” is perpendicular to the x-y plane, that is, in the thickness direction of the textile.

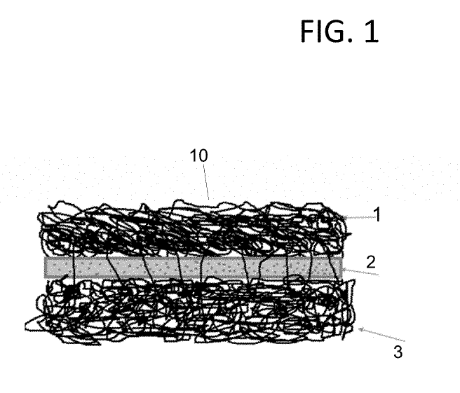

As shown in an embodiment of the present invention depicted in FIG. 1, a composite flame barrier 10 includes at least one nonwoven textile layer 1 comprising flame resistant fibers, and at least one sheet 2 of expandable inorganic fire resistant material combined with glass and or other inorganic fibers and a polymeric binder. The nonwoven layer 1 is mechanically attached to the sheet material by needlepunching, stitchbonding, sewing, quilting, or the like.

The nonwoven layer(s) may comprise up to 100% by weight of oxidized polyacrylonitrile (“OPAN”) fibers. For example, the flame resistant fibers in the nonwoven fiber layer may consist entirely of OPAN. In embodiments, the nonwoven layer consists of substantially 100% OPAN fibers.

In other embodiments, the nonwoven fiber layer 1 may include additional flame resistant fibers, in addition to OPAN, which may be organic fibers or inorganic fibers, selected from the group consisting of meta-aramids, para-aramids (such as diphenylether para-aramid), polybenzimidazole, polyimides, polyamideimides, novoloids, poly(p-phenylene benzobisoxazoles), poly (p-phenylene benzothiazoles), flame retardant viscose rayon, polyetheretherketones, polyketones, polyetherimides, and silica based fibers and polysilicic acid fibers derived from silica and sold under the tradename BelCoTex®. Such additional fibers may be present in an amount from about 0.1% by weight up to about 99.9% by weight of the nonwoven layer(s). In embodiments, the weight ratio of additional flame resistant fibers to OPAN is in a range of 10:90 to 90:10.

The weight of the nonwoven layer(s), whether entirely OPAN or comprising a fiber blend, is in a range of 1 oz/sq. yd. to 30 oz/sq. yd.

Mechanical attachment of the layers by needlepunching ensures that a significant proportion of fibers 5 from the nonwoven layer are forced through the sheet of expandable inorganic fire resistant material in the z direction. The layers of the composite flame barrier are needled together to pass the fibers in the nonwoven layers through the expandable graphite layer in the z direction to mechanically attach the materials together. The loading of binder in the sheet of expandable inorganic material should be low enough so as not to interfere with the needlepunching operation. Passing fibers through the expandable graphite creates an interlocking mechanism between the layers and eliminates the need for adhesives, resins or additional binders, reducing or eliminating combustible materials or heat-sensitive chemicals in the manufacture of the composite.

Additionally, mechanically attaching layers of nonwoven felts or spunlace materials to the expandable graphite layer affords advantages in manufacturing. Incorporating the intumescent materials in a sheet reduces the need to lay up multiple materials during the composite building process, while the holes created during needlepunching provide pathways for resins or chemicals used in a resin infusion stage of a composite construction process, allowing the flowable materials to penetrate through and saturate the layers.

The sheet material 2 according to the invention comprises at least an expandable inorganic (which may be exfoliating graphite, vermiculite, perlite, etc., as disclosed in the aforesaid U.S. Pat. No. 6,274,647), preferably present in an amount of 10-85% by weight of the sheet, glass and/or mineral fibers, present in an amount of 15-90% by weight and a small amount (up to about 10%) of a polymeric binder. In embodiments, PVA may be used as the binder to hold the sheet material together, although an acrylic or other known binder material may be used. The overall weight of the sheet material comprising the expandable inorganic may range from 1 oz./sq.yd. to 50 oz./sq.yd.

Additional ingredients such as fire resistant organic fibers, active fire retardant chemicals and particulates may also be included in the sheet material 2. Materials in sheet form capable of being positioned against a nonwoven fiber layer and needlepunched, while still retaining their integrity are particularly preferred. Suitable expandable graphite sheet materials for use with the invention include Technofire® brand expandable graphite sheet materials, made by Technical Fibre Products, United Kingdom.

As shown in FIG. 1, an additional nonwoven fire protecting layer 3 may be attached to the sheet of expandable inorganic flame barrier material opposite the first layer 1 of nonwoven. The composition of nonwoven layer 3 may be different or the same as the composition of first layer 1. However, the same fiber types in the same ranges may be used. Nonwoven layer 3 is preferably a needle punched felt and is preferably attached to the other layer(s) of the composite by needle punching.

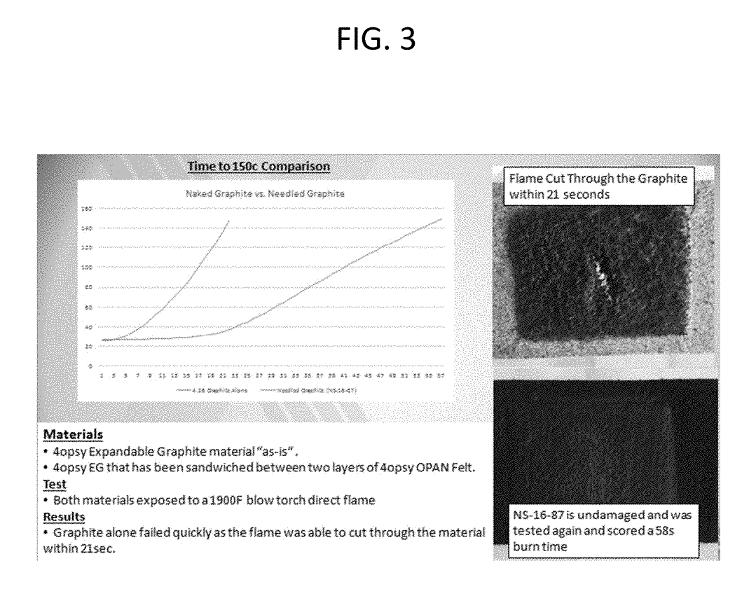

In another embodiment, depicted in FIG. 3, a woven layer 4, such as, without limitation, a plain or twill weave, may be attached on the opposite side of the sheet comprising the expandable inorganic material. The fibers of the woven layer 4 may be the same or different from the fibers of the nonwoven layer 1, and the same relative amounts of different fibers may be employed to make the woven layer 4 as are used to make nonwoven layer 1. In some embodiments, the woven layer may consist entirely of non-OPAN fibers, such as aramid. The nonwoven layer 3 or woven layers 4 may be mechanically attached to the sheet materials in the same manner as the nonwoven layer 1, by sewing, quilting or needlepunching. Preferably, the additional woven layer 3 or additional nonwoven layer 4 is attached to nonwoven layer 1 and the sheet material 2 containing the expandable inorganic in the same needlepunching step. The needlepunching step provides a plurality of pores in the material which is advantageous for a later resin impregnation step by an end user.

The additional woven and nonwoven layer(s) may be used to provide a desired finish on the surface of the product, and may comprise fire resistant fibers selected from the group consisting of OPAN fibers, meta-aramids, para-aramids (such as diphenylether para-aramid), polybenzimidazole, polyimides, polyamideimides, novoloids, poly(p-phenylene benzobisoxazoles), poly (p-phenylene benzothiazoles), flame retardant viscose rayon, polyetheretherketones, polyketones, and polyetherimides. In other embodiments, one or more of the woven or nonwoven textile layers may include inorganic flame resistant fibers, including, without limitation, basalt fibers, ceramic fibers, glass fibers, carbon fibers, and silica based fibers and polysilicic acid fibers derived from silica and sold under the tradename BelCoTex®. A woven layer of aramid contributes to structural strength of the finished composite which the nonwoven cannot provide on its own. Greater than 50 by weight BelCoTex® fibers in the additional nonwoven layer will contribute to the insulation properties of the product.

In embodiments, the nonwoven and/or woven layer(s) may include additional high temperature reinforcing fibers, selected from the group consisting of glass, mineral fibers, ceramic fibers, carbon fibers, stainless steel fibers and combinations thereof.

An advantage of a needlepunched construction according to the invention is the improved feel of the consolidated textile. Whereas intumescent material provided in sheet form with glass fibers may be difficult or uncomfortable to handle, combining the filled sheet with one or more layers of OPAN or OPAN blend textile on one or both sides makes the composite easier and more comfortable for the end user to install or use without irritation to the eyes or skin caused by the glass or mineral fibers. In other embodiments, a nonwoven layer may be positioned on one side and a woven layer may be positioned on the opposite side. In embodiments, the nonwoven and woven layers are positioned on opposite sides of the intumescent composite layer and consolidated by needlepunching. In some of the non-limiting examples below, the combined weight of the OPAN or OPAN blend layer(s) is at least about equal to the weight of the expandable inorganic sheet material, which ensures that the properties of the nonwoven material are prominent in the finished material.

In another aspect, textiles according to the invention are used for resin impregnation to make composites as an end use. In this aspect, the textiles of the invention, prior to resin impregnation, are referred to as “pre-pregs”. Pre-pregs integrated by needlepunching afford two principal advantages in connection with the impregnation process. First, because the nonwoven and woven layers are mechanically attached to the layer filled with expandable inorganic, the need for laying up multiple layers is avoided, thus simplifying the resin infusion process. Second, the needlepunching process pushes fibers (OPAN or OPAN blended with other fibers) through the sheet material, which creates a plurality of pores and pathways, allowing for improved wetting of the layered material and better integration of the layer properties. Thus, a pre-preg comprising a layer of nonwoven fire resistant fibers, and a sheet comprising expandable inorganic, consolidated by needlepunching is easier to use in the resin impregnation process than the conventional products.

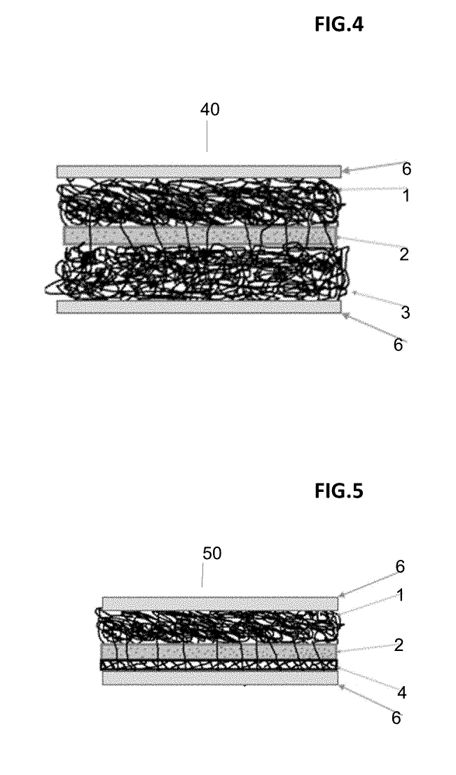

In other embodiments, a composite flame barrier may include one or more laminate layer(s) comprised of metal foil, coated paper, or polymeric film on an outer surface of the product. In the composite 40, depicted in FIG. 4, internal textile layers are assembled similar to FIG. 1 and attached by needlepunching. Thereafter, layers 6 of 1 mil aluminum foil are laminated to the opposite outer surfaces with heat and pressure. An adhesive, such as a thermoset adhesive which cures over time may also be used to adhere the foil to the outer layers. In the composite 50, depicted in FIG. 5, the internal layers include woven and nonwoven layers on opposite sides of the expandable graphite mat 2, respectively. Metal layers 6 of 1 mil aluminum are laminated on opposite outer surfaces. Foil is found block air movement through the material, reducing the movement of hot gasses in a fire and boosting the insulating effect of the felt/graphite composite.

A composite barrier according to the invention affords fire resistance and slows down the transmission of heat by providing greater depth of insulation when the expandable graphite expands. The properties of the invention may be partially captured in testing, including burn through tests. Preferably, a 12 oz/yd² sheet of a composite will burn through when exposed to a 1900 degree blow torch for at least 30 seconds, more preferably 40 seconds, and still more preferably 50 seconds.

### Example 1

A rolled textile according to FIG. 1 was prepared having a first nonwoven layer consisting of a 4 oz./sq.yd. blend of aramid and OPAN fibers in the form of a needle punch felt, a sheet material comprising a 4 oz./sq.yd. expandable graphite mat comprising glass fibers and a binder, commercially available under the Technofire® brand name, and a further nonwoven layer consisting of 4 oz/sq.yd. blend of aramid and OPAN fibers in the form of a needle punch felt. The layers were assembled by placing the expandable graphite sheet material between two layers of the blended felt and processing through a finishing loom where the fibers of the felt were moved through the 3 layers of material in the “Z” direction mechanically locking the 3 layers together. This method eliminates the need to use additional adhesives or other binders, which would otherwise increase the finished weight, while at the same time maintaining increased fire resistance.

### Comparative Example 1

As a comparative example, a 12 oz./sq.yd. expandable graphite mat was obtained from Technical Fibre Products. The material was an expandable graphite provided in a fibrous matrix with a high temperature resistant mineral fiber and an organic binder (sold under the tradename Technofire®) and having a weight of 12 oz/yd². Thus, Example 1 and Comparative Example 1 have the same areal weight and the composition of the graphite mat in Example 1 and Comparative Example 1 is substantially the same.

### Burn Through Test

A burn through test was conducted with a composite according to the invention (Example 1), compared to the prior art product having the same areal weight (Comparative Example 1). The results are shown in FIG. 3. Both materials were subjected to a 1900° F. blow torch direct flame and the time to burn through was measured. The prior art material exhibited burnthrough in 24 seconds. The material according to the invention exhibited burnthrough at 52 seconds, a marked improvement.

### Example 2

A rolled textile according to FIG. 1 is prepared having 4 oz./sq.yd. blend of BelCoTex® silica fibers and OPAN fibers in the form of a needle punch felt, a sheet material comprising a 4 oz./sq.yd. expandable graphite mat, and a nonwoven layer consisting of 4 oz./sq.yd. blend of silica fibers and OPAN fibers in the form of a needle punch felt. The layers are assembled according to Example 1: expandable graphite material is placed between two layers of the blended felt and processed through a finishing loom where the fibers of the felt are moved through the 3 layers of material in the “Z” direction mechanically locking the 3 layers together. The resulting consolidated material does not have significant glass fibers on the surface.

### Example 3

A rolled textile according to FIG. 4 was prepared with an aluminum foil outer layer. The inner layers were prepared as in Example 1, having 4 oz./sq.yd. OPAN fibers in the form of a needle punch felt, a 4 oz./sq.yd. graphite mat, and 4 oz./sq.yd. OPAN fibers in the form of a needle punch felt. As in Example 1, the expandable graphite material was placed between two layers of the felt and processed through a finishing loom where the fibers of the felt were moved through the 3 layers of material in the “Z” direction mechanically locking the 3 layers together. This method eliminates the need to use additional adhesives or other binders which reduces the finished weight and maintains increased fire resistance. The combined materials then have a 1 mil aluminum foil layer laminated to the exterior between a pair of rollers with the application of heat and pressure, thus encapsulating the OPAN/graphite/OPAN composite.

### Example 4

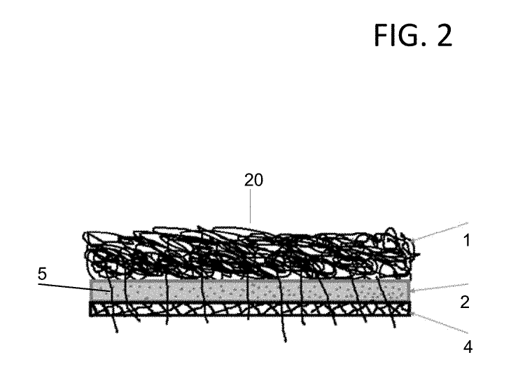

A rolled textile according to FIG. 2 is prepared having 4 oz./sq.yd. 100% OPAN fibers in the form of a needle punch felt, a 4 oz./sq.yd. graphite mat, and 8 oz./sq.yd. aramid 2×2 twill weave. To assemble, the expandable graphite sheet material is placed between the layer of the blended OPAN felt and the woven aramid and processed through a finishing loom where the fibers of the felt are moved through the 3 layers of material in the “Z” direction mechanically locking the 3 layers together.

### Example 5

A rolled textile according to FIG. 2 is prepared having 4 oz./sq.yd. % OPAN and aramid fibers in the form of a needle punch felt, a 4 oz./sq.yd. graphite mat, and 8 oz./sq.yd. aramid 2×2 twill weave assembled. The expandable graphite material is placed between the layers of the blended OPAN felt and mechanically attached as in the preceding example.

### Example 6

A rolled textile according to FIG. 2 is prepared having a nonwoven layer comprising 4 oz./sq.yd. OPAN and Belcotex® silica fibers in the form of a needle punch felt, a 4 oz./sq.yd. graphite mat sheet material, and 8 oz./sq.yd. aramid weave assembled by placing the graphite material between the layer of the blended OPAN felt and the woven aramid and processing through a finishing loom.

### Example 7

A rolled textile according to FIG. 2 is prepared having 4 oz./sq.yd. OPAN fibers in the form of a needle punch felt, a 4 oz./sq.yd. graphite mat, and 10 oz./sq.yd. OPAN/aramid plain weave assembled as follows. The expandable graphite material is placed between the layer of the blended OPAN felt and the woven aramid and processed through a finishing loom where the fibers of the felt are moved through the 3 layers of material in the “Z” direction mechanically locking the 3 layers together.

### Example 8

A rolled textile according to FIG. 5 is prepared having 4 oz./sq.yd. OPAN fibers in the form of a needle punch felt, a 4 oz./sq.yd. graphite mat, and 10 oz./sq.yd. opan and aramid plain weave. The expandable graphite material is placed between the layer of the blended OPAN felt and the woven fiber layer and processed through a finishing loom where the fibers of the felt are moved through the 3 layers of material in the “Z” direction mechanically locking the 3 layers together.

### Example 9

A rolled textile according to FIG. 2 is prepared having 4 oz./sq.yd. OPAN and silica fibers in the form of a needle punch felt, a 4 oz./sq.yd. graphite mat, and 8 oz./sq.yd. aramid twill or plain weave assembled with the expandable graphite material placed between the layer of the blended OPAN felt and the woven aramid and processed through a finishing loom to mechanically attach the 3 layers. The combined woven, nonwoven and graphite mat sheet materials then have a 1 mil aluminum foil layer laminated to the exterior on both sides thus encapsulating the OPAN/graphite/woven composite.

The composites according to the invention may be flexible enough that they can be provided in a roll format, with a texture and hand-feel much superior to glass fibers, yet with all the functionality of the conventional graphite mat materials. In many cases, the composites are suitable for use as intermediates or “pre-pregs” which can be impregnated with a thermoplastic resin to make rigid panels and the like. Further, the use of OPAN aramid, and/or silica fibers on one surface of the composite, including wovens, creates a significant array of product formats which can be adapted for a variety of passive fire protection environments.

The description of the foregoing preferred embodiments is not to be considered as limiting the invention, which is defined according to the appended claims. The person of ordinary skill in the art, relying on the foregoing disclosure, may practice variants of the embodiments described without departing from the scope of the invention claimed. A feature or dependent claim limitation described in connection with one embodiment or independent claim may be adapted for use with another embodiment or independent claim, without departing from the scope of the invention.

1. A composite flame or heat barrier material, consisting of two layers:
a first layer comprising nonwoven flame resistant fibers; and
a wet-laid material in sheet form consisting essentially of (i) a heat-expandable inorganic compound, (ii) glass or other inorganic fibers, and (iii) a polymeric binder holding the wet-laid material including the heat-expandable inorganic compound together, adjacent the nonwoven fiber layer;
wherein the first layer and the sheet comprising the heat-expandable inorganic compound are attached to each other by needlepunching, quilting or stitchbonding, and wherein fibers of the first layer are positioned in the z-direction in the sheet material.

2. The composite material of claim 1, wherein the first layer comprises oxidized polyacrylonitrile flame-resistant fibers.

3. The composite material of claim 1 wherein the flame resistant fibers in the first layer are 100% oxidized polyacrylonitrile fibers.

4. The composite material of claim 2, wherein the first layer further comprises additional flame resistant fibers selected from the group consisting of meta-aramid, para-aramid, polybenzimidazole, polyimides, polyamideimides, novoloids, poly(p-phenylene) benzobisoxazoles, poly(p-phenylene) benzothiazoles, flame retardant viscose rayon, polyetheretherketones, polyketones, polyetherimides, silica based fibers, polysilicic acid fibers derived from silica fibers, and combinations thereof.

5. (canceled)

6. (canceled)

7. (canceled)

8. (canceled)

9. (canceled)

10. (canceled)

11. (canceled)

12. The composite of claim 1, wherein the first layer is attached to the sheet comprising the heat expandable inorganic compound by needlepunching.

13. (canceled)

14. A process for making a composite heat or flame barrier material according to claim 1, comprising the steps of:
positioning a first layer comprising nonwoven flame-resistant fibers against a wet-laid material in sheet form consisting essentially of (i) an expandable inorganic fire resistant compound (ii) glass, or other inorganic fibers, and (iii) a polymeric binder; and
needlepunching the first layer and the wet-laid sheet material to transfer fibers of the first layer through the sheet material in the z direction.

15. The process of claim 14, wherein the flame resistant fibers in the first layer comprise oxidized polyacrylonitrile fibers.

16. (canceled)

17. (canceled)

18. (canceled)

19. (canceled)

20. (canceled)

21. The composite of claim 12, wherein the composite is a pre-preg adapted for thermoplastic resin impregnation.

22. The composite according to claim 12, wherein the heat expandable inorganic compound comprises expandable graphite.
